(19) United States
(12) Patent Application Publication
(10) Pub. No.: US 2016/0222720 A1
(43) Pub. Date: Aug. 4, 2016

(54) APPARATUS AND METHOD FOR AN ARMOR DOOR

(71) Applicants: Glenn Tamberino, Huntington Station, NY (US); John Sparaco, South Huntington, NY (US)

(72) Inventors: Glenn Tamberino, Huntington Station, NY (US); John Sparaco, South Huntington, NY (US)

(21) Appl. No.: 14/614,409

(22) Filed: Feb. 4, 2015

(51) Int. Cl. E06B 5/10; E06B 5/14; E06B 5/12; E06B 7/14; E06B 7/16

(52) U.S. Cl. CPC E06B 5/10; E06B 5/103; E06B 7/14; E06B 7/16; E06B 5/12; E06B 5/14

(57) ABSTRACT

A door with enhanced security includes four sides that define a side perimeter of the door. The side perimeter connects to an interior face and an exterior face of the door. An aperture is defined in the door that extends through the door between the exterior face and the interior face. A gate is connected to the door that includes a plurality of slats. The gate is selectively movable in the aperture of the door. The aperture is at least partially open in a first position of the gate and the aperture is closed in a second position of the gate. A locking mechanism secures the gate in position in the aperture of the door. A screen connects to the door and is positioned in the aperture of the door.

### BACKGROUND OF THE INVENTION

1. Field of the Invention

The present invention relates to doors and in particular to doors with enhanced security that accommodate the flow of air.

2. Description of the Related Art

Doors are commonly constructed with enhanced security aspects that can include additional bolts, reinforcing and sophisticated locking mechanisms. Doors, however, do not readily address the need to be able to convert between an enhanced security door and a door that can provide a secure source of external air into a commercial space.

### SUMMARY OF THE INVENTION

A door with enhanced security is described that comprises a first elongate side that is opposed to a second elongate side and a third side that is opposed to a fourth side. The first side and second side connect to the third and fourth side to define a rectangular perimeter of the door. The door has an interior face and an opposed exterior face that connect to sides. The door defines an aperture that extends through the door from the exterior face to the interior face.

A gate is connected to the door. The gate is selectively movable in the aperture of the door between a first position with the gate at least partially positioned in the aperture and the aperture is at least partially open and a second position with the aperture closed by the gate. The gate includes a plurality of interconnected slats. A locking mechanism secures the gate in at least one position in the door. A screen is positioned in the aperture of and connected to the door. The gate is stored in a hood connected to the interior face of the door. The gate is preferably retracted in a roll and stored in the hood.

The door includes a track and the track receives and guides the movement of the gate. A space is defined in the door between the track and an inside surface of the exterior face of the door. The space can be configured to receive and securely retain the screen in position in the door. The screen is positioned in the aperture of the door. The screen can also be an insert that is a protective sheet or layer with perforations. The insert is suitable to act as a protective layer for an external door. The insert can also be a separate assembly from the screen that is connected to the door to limit access through the aperture. The insert is preferably perforated sheet metal. In an alternative arrangement of the door, the gate is movable and positionable in a space between an inside of the exterior face of the door and the track. In this arrangement, the track is configured to receive and securely position the screen in the aperture.

An actuation mechanism can assist in or provide the movement of the gate between the first position and the second position. The locking mechanism of the door can secure the gate in the second position. The locking mechanism can also secure the gate in a plurality of positions between the first position and the second position. The locking mechanism can be manually actuated, mechanically actuated and/or electrically actuated.

The fourth side of the door defines a second aperture that provides access to the space defined in the door. The second aperture has a door that provides access to and secures the second aperture in a closed position. The second aperture can provide access to the screen in the space.

The door with enhanced security is preferably an external door that provides a weatherproof interface against external weather conditions. Weatherproof as defined herein includes an air tight and waterproof sealing of the aperture as well as the interface between the door and the doorframe and/or any other interfacing external structure. Various forms of weatherproofing and/or insulation provide air and water tight seals that make the door weatherproof. For example, the hinged connection between the slats and the interface between the gate and the tracks can include insulation that provides a weatherproof interface. The gate in the second position preferably includes the secure closing of the aperture in the door that further includes a weatherproof closure of the aperture.

While many doors have provided apertures that have movable glass and/or screens that are alternately positionable, these doors lack the ability to simultaneous provide a high security enclosure and the free flow of air. Heretofore there has never been a door with a selectively movable gate that provides a high security closure for an aperture in the door in combination with an enhanced security screen for the free flow of air through the aperture of the door.

### BRIEF DESCRIPTION OF THE DRAWINGS

FIG. 1 is a rear, first side and top perspective view of an apparatus and method for an armor door that includes a gate in an aperture of the door;

FIG. 2 is a front, second side and top perspective view of the armor door of FIG. 1 without the gate;

FIG. 3 is a partial cross-sectional view of FIG. 1 taken along lines 3-3 showing the screen and gate extended from the hood of the door;

FIG. 4 is a rear view of the armor door of FIG. 1, with the gate in the closed position; and

FIG. 5 is a partial cross-sectional view of a second arrangement of the gate and screen of the apparatus and method for an armor door of FIG. 1.

### DETAILED DESCRIPTION OF THE INVENTION

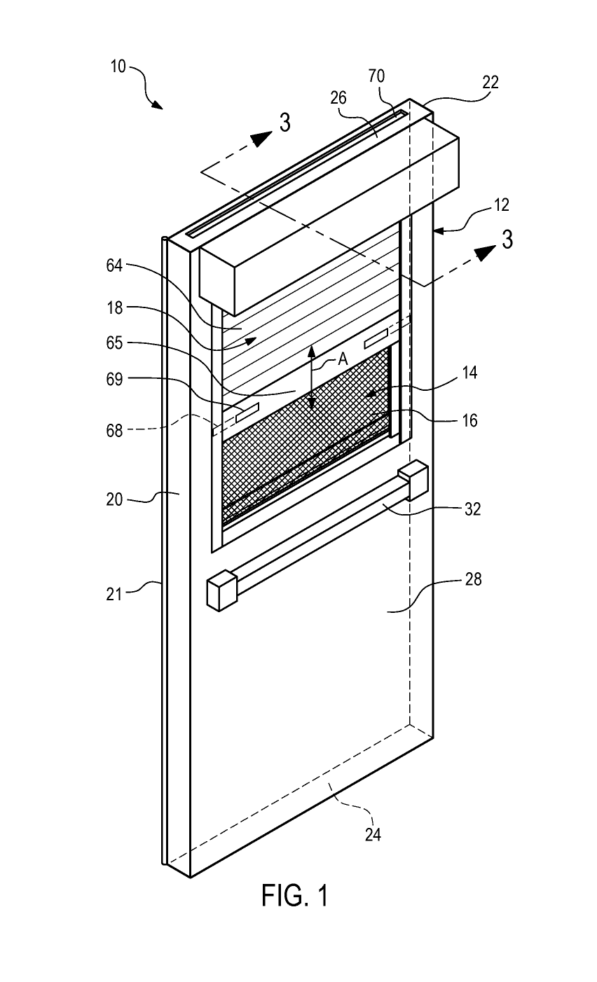

Referring initially to FIG. 1, an apparatus and method for an armor door 10 includes a door 12, an aperture 14 that is defined in door 12, a screen 16 and a gate 18. Door 12 includes a first side 20, a second side 22 opposed to first side 20, a third side 24 and a fourth side 26 opposed to third side 24. First side 20 and second side 22 are elongate sides connected by the third or bottom side 24 and fourth or top side 26. Sides 20, 22, 24 and 26 have a depth that is the thickness of door 12. First side 20, second side 22, third side 24 and fourth side 26 define a perimeter for door 12 that includes the width, height and thickness of door 12. Door 12 in this preferred embodiment has standard exterior door dimensions for width, height and thickness, but door 12 can be fabricated in any size or as any type of door to include sliding and double doors arrangements.

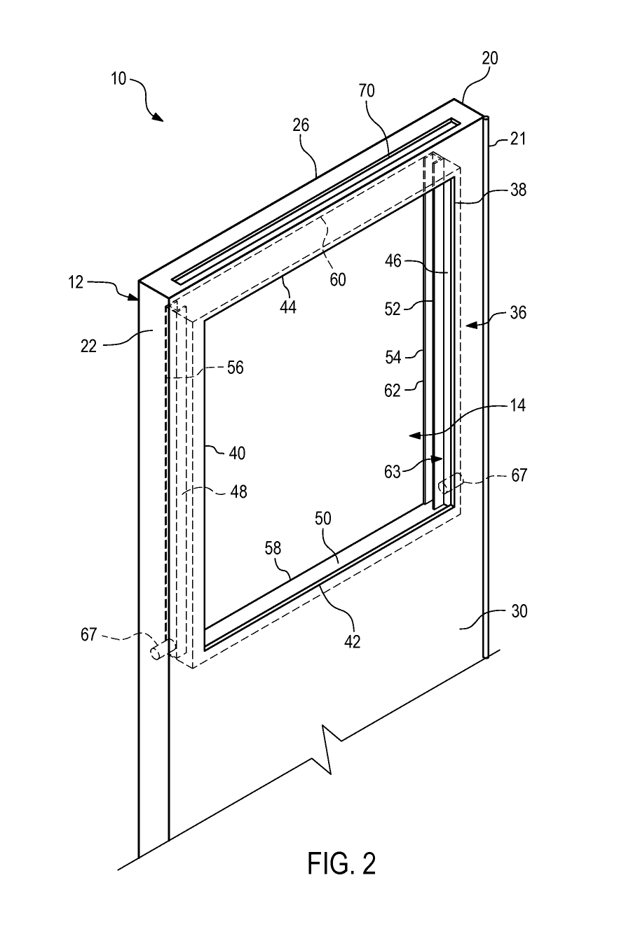

As shown in FIGS. 1 and 2, door 12 includes an interior face 28 and an exterior face 30. Interior face 28 and exterior face 30 connect to opposing sides of sides 20, 22, 24 and 26. A hinge 21 is preferably connected to side 20 and can be any type of hinge to include a continuous hinge that securely connects door 12 to at least the adjoining door frame of door 12. A first door handle 32 is connected to interior face 28 and includes the associated latching mechanism and a latch plate that connects to a door frame. Armor door 10 can optionally further include a door frame that can be connected into a wall structure with door 12.

Aperture 14 is preferably located between handle 32 and fourth side 26, but can extend below handle 32 towards third side 24. Aperture 14 of door 12 extends between the interior face 28 and exterior face 30. Aperture 14 is defined in exterior face 30 by a rim 36. In this preferred embodiment, rim 36 includes a first edge 38 in proximity and approximately parallel to first side 20, an opposed second edge 40 in proximity and approximately parallel to second side 22, a third edge 42 positioned in fixed spaced separation and approximately parallel to third side 24 and a fourth edge 44 in proximity and approximately parallel to side 26. Third edge 42 and fourth edge 44 connect to opposing edges 38 and 40 to form continuous rim 36 and define aperture 14 in exterior face 30. Edges 38, 40, 42 and 44 preferably define a rectangular shape rim 36.

Door 12 includes a plurality of interior walls between faces 28 and 30. A first interior wall 46 is in proximity and approximately parallel to first side 20, a second interior wall 48 is in proximity and approximately parallel to second side 22 and a third interior wall 50 is approximately parallel and in fixed spaced separation to third side 24. Walls 46, 48 and 50 define a U-shape that is open towards fourth side 26. Walls 46, 48 and 50 are recessed in fixed spaced separation from edges 54, 56 and 58 of rim 52 defined in exterior face 30. Walls 46, 48 and 50 preferably extend between and are connected to faces 28 and 30.

Aperture 14 is defined in interior face 28 by a rim 52. In this preferred embodiment, rim 52 includes a first edge 54 in proximity and approximately parallel to first side 20, an opposed second edge 56 in proximity and approximately parallel to second side 22, a third edge 58 that is positioned in fixed spaced separation to and approximately parallel to third side 24 and a fourth edge 60 in proximity and approximately parallel to fourth side 26. Third edge 58 and fourth edge 60 connect to opposing edges 54 and 56 to form rim 52 and define aperture 14 in interior face 30. First interior wall 46, second interior wall 48 and third interior wall 50 connect to first edge 38, second edge 40 and third edge 42, respectively. Edges 54, 56, 58 and 60 preferably define an approximately rectangular shape rim 52.

Aperture 14 of door 12 in this preferred embodiment is defined by rims 36, 52, interior walls 46, 48, 50 and fourth side 26. Interior walls 46, 48 and 50 are recessed from rim 36 of exterior face 30. Interior walls 46, 48 and 50 define edges 54, 56 and 58, respectively with interior face 28. In this preferred embodiment, third interior wall 50 defines a ledge between first interior wall 46 and opposing second interior wall 48. Wall 50 connects to third side 58 of rim 52 of interior face 28. Rims 36 and 52 define aperture 14 as having a quadrangular shape in door 12, but it is understood that rims 36 and 52 can define any shape or size of aperture 14 in door 12.

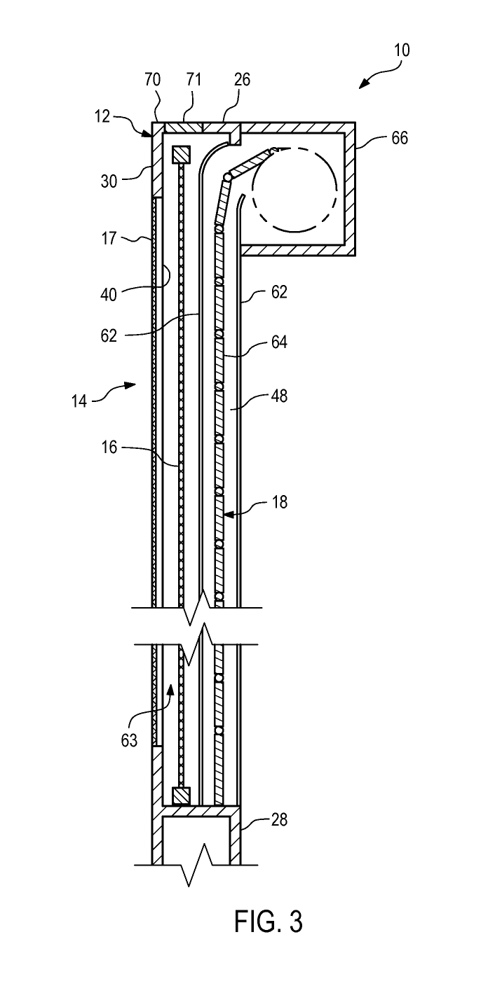

Referring now to FIGS. 1-3, a pair of tracks 62 are aligned and positioned in opposition on first interior wall 46 and second interior wall 48. Tracks 62 are preferably U-shaped channels positioned in fixed space separation from the inside of exterior face 30. Tracks 62 preferably extend from or are in proximity to third interior wall 50 along each respective first interior wall 46 and second interior wall 48 for a predefined distance towards opposing fourth side 26. Tracks 62 receive and accommodate the movement of gate 18 between a first open position and a second closed position.

A space 63 is defined in door 12 between the inside of exterior face 30, wall 46, wall 48, wall 50, side 26 and tracks 62. Space 63 is defined to receive screen 16. Screen 16 is selectively removable and replaceable within space 63. Screen 16 has a frame that can have a tight and secure fitting relationship in space 63 of door 12. This can include a tight fit between side 30, tracks 62, wall 46, wall 48, wall 50 and side 26. The secure fitting of screen 16 can be the frame of screen 16 connecting to wall 50, tracks 62 and/or walls 46, 48 and 50. Screen 16 is preferably slidably positioned in space 63. Alternatively, screen 16 can be received in a second channel connected to tracks 62 or in a separate channel or track 62 positioned in space 63.

Screen 16 is preferably a high security screen. In the preferred embodiment, screen 16 is positioned in a frame and is resistant to puncture and cutting by sharp objects such as knives. The frame of screen 16 is preferably metal, but it can be alternative materials such as but not limited to composite materials. Screen 16 can further include bars and/or other forms of enhanced security measures to provide additional levels of protection against intrusion through aperture 14. Armor door 10 can include sensors to detect the movement of screen 16 in door 12 and/or penetrations of screen 16. Screen 16 can also provide limited or no visibility from exterior face 30 of door 12 to the interior face 28 of door 12 while accommodating visibility through screen 16 from the interior face 28 of door 12.

Screen 16 of door 12 can alternatively be an insert 17 that includes a plurality of apertures. Insert 17 can be a grid, series of bars, lattice or any other structure that acts as a security barrier, but accommodates a free flow of air. In one preferred embodiment, insert 17 is an alloy type 1008 carbon steel perforated sheet. Insert 17 provides an enhanced level of security above that of screen 16. Insert 17 is located over or in aperture 14 door 12. Insert 17 is preferably located in space 63 separately, with and/or as an integrated assembly with screen 16, in exterior rim 36 or connected to the external face of external side 30. Insert 17 can have a fixed connection to door 12 or be a removable and replaceable assembly. The quantity and dimensions of the perforations defined in insert 17 can vary depending upon the desired application. Insert 17 can also replace screen 16 in door 12.

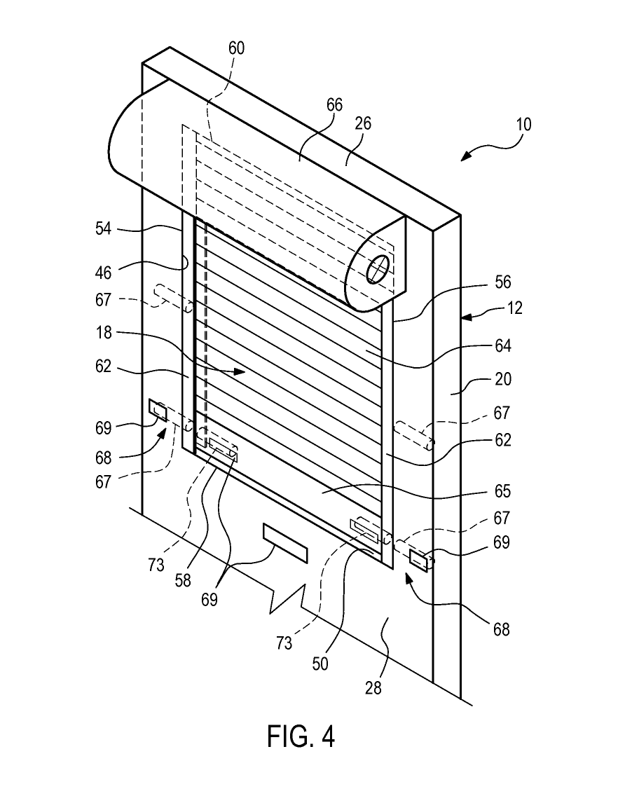

Referring now to FIGS. 1-4, gate 18 can be selectively moved to open and close aperture 14. Gate 18 includes a plurality of slats 64 that are interconnected to form a continuous, preferably solid, wall or gate. Gate 18 is movable between a first position and a second position as shown by arrows A. In the first position of gate 18, aperture 14 is at least partially open and in the second position gate 18 closes aperture 14.

Hood 66 is connected to door 12. In this preferred embodiment, hood 66 is connected to interior side 28 of door 12 in proximity to fourth side 26. Hood 66 includes a mechanism that winds and unwinds gate 18 for the movement of gate 18 between the first position and second position. The mechanism can be mechanical, electro-mechanical, hydraulic, pneumatic or electronic device that drives the movement of gate 18 between the first position and the second position. The winding of gate 18 into hood 66 can include gate 18 being partially recessed between the interior face 28 and exterior face 30 of door 12 or retracted into hood 66 and external to door 12. Hood 66 provides for the storage of gate 18. At least a portion of gate 18 can be retained in hood 66 when gate 18 is in the first position. Gate 18 can be moved between the first position and the second position by any means to include manually pulling down on gate 18 within door 12, by one or more handles/actuators positioned on the outside of or connected to hood 66 or electrically.

Moving from the first position to the second position of gate 18, tracks 62 interface with and receive gate 18 from hood 66. Gate 18 is extended to be in direct contact with wall 50 to securely block aperture 14. Gate 18 is received by and has a secure sliding engagement with tracks 62 that extend at least partially into aperture 14. Gate 18 preferably provides a solid air-tight weatherproof external interface to weather conditions. In addition, tracks 62 can provide an air tight sealing interface with slats 64 of gate 18. Slats 64, are flexibly connected together via a preferably hinged interface to accommodate the winding and storage of gate 18 in hood 66 and the movement of gate 18 between the first position and the second position. In the preferred embodiment, slats 64 are connected together by hinges that allow the required movement of slats 64 between the first position and the second position. The hinges between slats 64 can be flexible hinges that provide a continuous gate 18 structure and/or gate 18 can be provided with a weatherproofing layer. Slats 64 are preferably solid elements with a sealing interface between slats 64. Door 12 includes weather proofing, insulation, seals and/or weather stripping materials such as, but not limited to cross linked polyethylene foam, sponge rubber, neoprene and vinyl materials.

Door 12 includes a locking mechanism 68 that securely connects gate 18 in a position relative to aperture 14. In one preferred embodiment, slats 64 include one or more locking mechanisms 68 that engage and fix gate 18 in position in door 12. Preferably, a distal slat 65 includes locking mechanism 68 that engages gate 18 with apertures 67 in first interior wall 46, second interior wall 48 and/or third interior wall 50 to secure gate 18 in the second position. The term slats 64, as defined herein, includes slat 65 and the interface or hinge between slat 64 and slat 65. The locking mechanism 68 in distal slat 65 can include, for example, an actuator 69 in distal slat 65 that moves at least one bolt 73 to extend from within distal slat 65 into at least one of apertures 67 in interior walls 46, 48 and/or 50 of door 12. Preferably, locking mechanism 68 includes one or more actuators 69 that move opposing bolts 73 from distal slat 65 into the opposing apertures 67 defined in opposing interior walls 46 and 48 to secure gate 18 at a desired location in door 12. The desired location can define a desired size of opening of aperture 14 and/or the closure of aperture 14. Additional apertures 67 can be located along opposing interior walls 46 and 48 to define secure positions for slat 65 of gate 18 so as to accommodate a range of different sizes of openings of aperture 14. Locking mechanism 68 can be opened and closed by any means to include by the direct hand movement of the bolts in distal slat 65, a separate mechanical actuator 69 for locking mechanism 68, an electrically actuated locking mechanism 68. It is understood that locking mechanism 68 can also connect gate 18 to third interior wall 50 in the closed position of gate 18.

Locking mechanism 68 can also be located in door 12 and connect to gate 18. In this preferred embodiment, locking mechanism 68 is positioned in door 12 and engages gate 18 through or with first interior wall 46, second interior wall 48 and/or third interior wall 50 to secure gate 18 in the second position covering aperture 14. Locking mechanism 68 in door 12 includes one or more actuators 69 positioned on interior face 28. For example, one actuator 69 can have multiple settings for different positions of gate 18 in aperture 14 or multiple actuators 69 can be positioned on interior face 28 to provide for the desired position of gate 18 and size of opening of aperture 14. Alternatively, a powered locking mechanism 68 can secure gate 18 in position at any location along tracks 62 and block any additional movements of gate 18 along tracks 62.

First door handle 32 on interior face 28 can have any shape or structure, but is preferably a safety bar type door handle. Door 12 can optionally include a second door handle 34 that is approximately opposed to first door handle 32. Second door handle 34 can be omitted and door 12 opened solely by a key from the exterior face 30. When present second door handle 34 can have any shape to perform the opening function to include a bent plate or traditional handle. Armor door 10 preferably includes a door locking mechanism that is connected to first door handle 32.

Door 12 interior face 28 and exterior face 30 are preferably metal, but could be any material suitable for the use in a security type door. Additional materials of construction of door sides 20, 22, 24 and 26 as well as faces 28 and 30 can include, but are not limited to composite materials and natural materials such as wood or other materials that are at least fire resistant and can be reinforced as required. Door 12 sides 20, 22, 24 and 26 as well as faces 28 and 30 are preferably connected by standard means that can include one or more of welding, mechanical connections and bonding using heat and/or adhesives. Door 12 can have a solid core and/or include an interior frame structure.

In one exemplary preferred embodiment, door 12 has standard sized dimensions for a commercial entry door that includes an approximate width of thirty-six (36) inches, an approximate thickness of one and three-quarter (1¾) inches and an approximate height of eighty-four (84) inches. Aperture 14 of door 12 is defined by a rim 36 in exterior side 30. In this exemplary preferred embodiment aperture 14 rim 36 has lateral dimensions between first edge 38 and second edge 40 of approximately twenty-seven and three quarters (27¾) inches and dimensions between third edge 42 and fourth edge 44 of approximately thirty-two and one-half (32½) inches. In one preferred embodiment, aperture 14 in exterior face 30 has lateral dimensions between first edge 54 and second edge 56 of approximately twenty-seven and three quarters (27¾) inches and dimensions between third side 58 and fourth side 60 of approximately thirty-three and a half (33½) inches.

Armor door 10 has advantages that include a high security door that can selectively move gate 18 to open aperture 14 covered by an insert 17 and/or screen 16 for the free exchange of air. The position of gate 18 inside screen 16 also accommodates a simplified direct manual movement of gate 18. The dimensional differences between rim 52 and walls 46, 48 and 50 and external position of screen 16 provide a reduce access to gate 18 that also enhances the security of door 12.

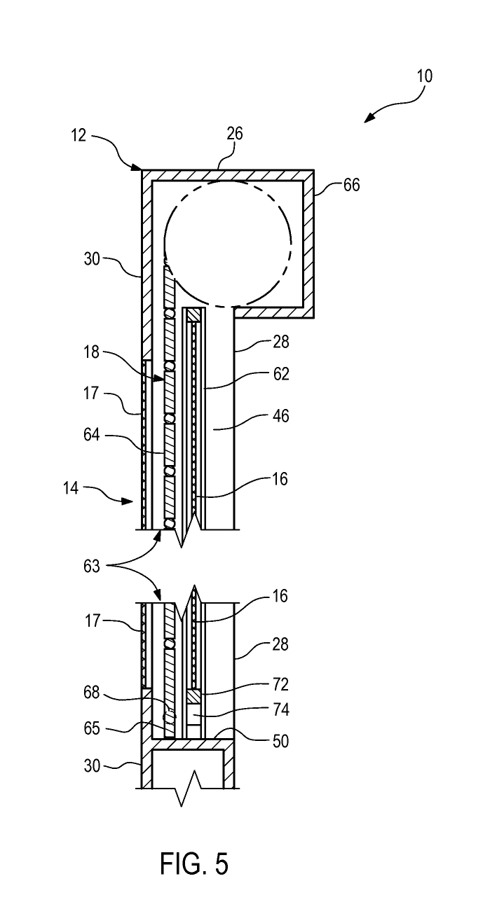

As shown in FIGS. 2 and 5, door 12 can have an alternative structural arrangement in which gate 18 is positioned external to screen 16 in space 63 and tracks 62 receive screen 16. The inside of exterior face 30 and tracks 62 or another set of tracks can assist in the guiding of gate 18 into and from space 63.

In this alternative structural arrangement, hood 66 can be connected to the inside of exterior face 30 and/or interior face 28 and the winding of the plurality of slats 64 of gate 18 is positioned at least partially in door 12. As described previously, gate 18 in the second position is in apposition with and/or interfaces with third interior wall 50 and can be secured to first interior wall 46, second interior wall 48 and/or third interior wall 50.

Continuing with the alternative structural arrangement, when locking mechanism 68 is positioned in distal slat 65 and the manual engagement of the locking mechanism 68 for gate 18 is desired, a pedestal wall 72 can extend from third interior wall 50 that is aligned with screen 16 that provides access to gate 18 distal slat 65 and locking mechanism 68. Pedestal wall 72 securely engages the frame of screen 16 and provides one or more apertures 74 with secure covers that can be opened and closed to provide manual access to space 63 and to actuate locking mechanisms 68 located in distal slat 65. Locking mechanism 68 can also secure gate 18 to first interior wall 46, second interior wall 48 and/or third interior wall 50 remotely via mechanical or electrical locking mechanisms 68 with or without pedestal wall 72 such as described previously with actuator 69 located on the interior face 28 of door 12. Screen 16 can be removed and replaced in this embodiment through side 22 and wall 48 or through rim 36.

The alternative structural arrangement provides advantages that include a high security door that accommodates the selective movement gate 18 to vary the size of the aperture 14 and screen 16 opening for the free exchange of air. This arrangement also has the advantage that by gate 18 being positioned external to screen 16 it reduces the likelihood of external damage to screen 16. Further, by hood 66 being connected to exterior face 30, the length of hood 66 that extends outward from interior face 28 can be reduced.

Referring now to FIGS. 1-5, in operation the apparatus and method for an armor door 10 provides a door 12 that can remain secure while selectively providing fresh air ventilation through screen 16 in aperture 14.

Screen 16 is preferably removed and replaced through an aperture 70 in door 12. In the preferred embodiment aperture 70 is defined in second side 22 and/or fourth side 26. Aperture 70 preferably includes a cover 71 that can be fastened and unfastened to provide access to and securely close aperture 70. The connection between the cover for aperture 70 and door 12 can be of any type to include friction, fasteners, hinged, electrically actuated or biased for example. To remove and replace screen 16, door 12 is opened sufficiently to open cover 71 and then access to is provided through aperture 70 and into space 63. Screen 16 can then be readily removed and a replacement screen 16 positioned in space 63. Similarly, insert 17, when positioned in space 63 or in exterior rim 36, can be accessed and/or removed separately or as an integrated assembly of screen 16 and insert 17 from space 63.

In the first position of gate 18, aperture 14 is at least partially open and gate 18 is at least partially withdrawn into hood 66. Gate 18 slat 65 can be securely positioned in a plurality of locations along first interior wall and second interior wall 48 to provide varying sizes of aperture 14 in door 12. When gate 18 is fully retracted into hood 66, aperture 14 is at the maximum opening.

As described previously, gate 18 can be moved between the first position and second position manually, by a mechanical device and/or by an electrically powered device. Mechanical devices can include for example a crank or a chain to actuate the winding or unwinding of gate 18 that can be positioned on or connected to hood 66 of door 12 or directly on face 28 of door 12. Mechanical assistance can also include a bias to a preferred position of gate 18. Electrically powered devices include drive motors to wind and/or unwind gate 18 that can be selectively actuated from a nearby electrical switch or remotely. To securely close gate 18 in door 12, distal slat 65 of gate 18 is moved to a position in apposition with third interior wall 50 and secured using locking mechanism 68. Locking mechanism 68 can be similarly actuated by direct manual activation, through mechanically actuated devices, electrically actuated through local switches or remotely. It is understood that one electromechanical device is capable of moving gate 18 and actuating locking device 68.

In the preceding specification, the present disclosure has been described with reference to specific exemplary embodiments thereof. It will be evident, however, that various modifications, combinations and changes may be made thereto without departing from the broader spirit and scope of the invention as set forth in the claims that follow. While the present disclosure is described in terms of a series of embodiments and/or arrangements, the present disclosure can combine one or more novel features of the different embodiments. The specification and drawings are accordingly to be regarded in an illustrative manner rather than a restrictive sense.

What is claimed is:

1. A door with enhanced security, the door with enhanced security comprises:
a door, the door includes a first side, a second side opposed to the first side, a third side and a fourth side opposed to the third side, the first side and second side connect to the third and fourth side to define a perimeter of the door, the door has an interior face and an opposed exterior face that connect to the sides;
an aperture defined in the door, the aperture extends through the door from the exterior face to the interior face;
a gate connected to the door, the gate includes a plurality of slats, the gate selectively movable in the door, the aperture at least partially open in a first position of the gate and the aperture closed in a second position of the gate, a locking mechanism that secures the gate in a position in the aperture of the door; and
a screen connected to the door, the screen positioned in the aperture of the door.

2. The door of claim 1, wherein the door includes a channel and the gate interfaces with the channel for movement between the first position and the second position.

3. The door of claim 2, wherein the door defines a space between an inside surface of the exterior face and the channel, the screen positioned in the space.

4. The door of claim 1, wherein a hood is connected to the door, the gate positionable in the hood.

5. The door of claim 1, wherein an insert is positioned in the aperture and connected to the door.

6. The door of claim 5, wherein the door defines a space between the inside surface of the exterior face and the channel, the gate movably positioned in the space.

7. The door of claim 1, wherein the gate in the second position provides the door with a weatherproof external interface.

8. A door with enhanced security, the door with enhanced security comprises:
a door that includes a first side, a second side opposed to the first side, a third side and a fourth side opposed to the third side, the first side and second side connect to the third and fourth side to define the perimeter of the door, the door has an interior face and an opposed exterior face that connect to sides;
an aperture defined in the door, the aperture extends through the door from the exterior face to the interior face;
a gate connected to the door, the gate includes a plurality of slats, the slats connected by hinges, the gate a solid barrier, the gate selectively movable in the aperture of the door, the aperture at least partially open in a first position of the gate and the aperture closed in a second position of the gate, a locking mechanism secures the gate in the second position in the door, the door has a weatherproof external interface with the gate in the second position, a hood connected to the door, the gate storable in the hood; and
a space defined in the door, a screen located in the space and in the aperture of the door.

9. The door of claim 8, wherein a track is defined in the door and the track receives the gate, the space defined in the door between the track and an inside of the exterior face of the door, the space configured to receive and securely retain the screen in position in the door, the screen positioned in the aperture.

10. The door of claim 8, wherein the gate is movably positioned between an inside of the exterior face of the door and a track, the track receives and securely positions the screen in the aperture.

11. The door of claim 8, wherein the locking mechanism secures the gate in at least one position.

12. The door of claim 8 that further includes an actuation mechanism that assists in the movement of gate between the first position and the second position.

13. The door of claim 8, wherein a track is defined in the door and the track receives the screen, the space defined in the door between the track and an inside of the exterior face of the door, the space configured to receive and securely retain the gate in position in the door, the screen positioned in the aperture.

14. The door of claim 8, wherein the fourth side of the door defines a second aperture and the second aperture provides access to the space in the door.

15. The door of claim 8, wherein the gate in the second position provides a weatherproof closing of the aperture of the door.

16. A method of providing a door with enhanced security, the method comprising:
providing a door, the door includes an interior face and an opposed exterior face that connect to four sides, an aperture defined in the door, the aperture extends through the door from the exterior face to the interior face, a gate connected to the door, the gate includes a plurality of slats, the slats connected by hinges, the gate selectively movable in the aperture of the door, a locking mechanism connected to the door for securing the gate in a position in the door, a screen located in the aperture of the door;
moving the gate to a first position of the gate, the first position of the gate including the aperture at least partially open;
moving the gate to a second position of the gate, the second position of the gate including the gate closing the aperture, the second position including the door having a weatherproof external interface;
locking the gate in position in the aperture using the locking mechanism to secure the gate in at least one position in the aperture of the door.

17. The method of providing a door of claim 16, wherein the moving of the gate between the first position and the second position further includes moving the gate in a track defined in the door.

18. The method of providing a door of claim 16, wherein the moving of the gate further includes moving the gate between an inside of the exterior face of the door and moving the screen in a track, the track in the aperture.

19. The door of claim 16, wherein the step of moving the gate to the first position includes positioning at least a portion of the gate in a hood.

20. The method of providing a door of claim 16, wherein the step of moving the gate to the second position includes the slats of the gate having an air tight sealing interface between each slat and the gate having a weatherproof closing of the aperture and the gate having a weatherproof interface with the door.
